(19) United States
(12) Patent Application Publication
(10) Pub. No.: US 2012/0212709 A1
(43) Pub. Date: Aug. 23, 2012

(54) FLY EYE LENS, OPTICAL UNIT, AND PROJECTION DISPLAY DEVICE

(76) Inventor: Akihiro Osaka, Tokyo (JP)

(21) Appl. No.: 13/505,274

(22) PCT Filed: Nov. 4, 2009
(86) PCT No.: PCT/JP2009/068824

§ 371 Date: Apr. 30, 2012

(51) Int. Cl. G03B 21/14; G02B 27/12

(52) U.S. Cl. 353/38; 359/621

(57) ABSTRACT

Provided is a fly eye lens capable of preventing the generation of steps on the boundaries between cells. The fly eye lens includes a plurality of cells arranged on first plane α. The plurality of cells includes a pair of cells adjacent to each other, which have spherical centers on second plane β parallel to first plane a and parts of spherical surfaces whose spherical radius differ, from each other, those parts being surfaces. The pair of cells satisfies the relationship of R_{I}²−L_{I}²=R_{O}²−L_{O}², where R_{I} is a spherical radius of the surface of one of the cells, R_{O} is a spherical radius of the surface of the other cell, L_{I} is a distance between the spherical center of the surface of one of the cells and a boundary surface between the pair of cells, and L_{O} is a distance between the spherical center of the surface of the other cell and the boundary surface between the pair of cells.

### BACKGROUND ART

A certain projection display device that projects an image to a screen or the like includes a fly eye lens configured to uniformize the illuminance distribution of light emitted from a light source. The fly eye lens includes a plurality of rectangular lenses (hereinafter, “cells”) arranged in a matrix. Each cell is, for example, a plano-convex lens that has a front surface formed to be part of a spherical surface and a back surface formed to be flat.

The projection display device generally includes two fly eye lenses, which makes a pair. One of the two fly eye lenses that is close to the light source is referred to as a first fly eye lens, and the other that is far from the light source is referred to as a second fly eye lens. The first fly eye lens and the second fly eye lens have cells corresponding to each other. In other words, the light emitted from the light source is transmitted through each cell of the first fly eye lens, and then enters to the corresponding cell of the second fly eye lens.

FIG. 1 shows the surface of a general fly eye lens. This fly eye lens has seventy six cells arranged in ten vertical columns and eight rows. In this case, the row direction of each cell is a horizontal direction, while the column direction of each cell is a vertical direction.

In FIG. 1, the position of the center of a spherical surface (hereinafter, “spherical center”) defining the shape of the surface of each cell is indicated by a mark x. In this fly eye lens, the spherical center is located on an axis (hereinafter, “cell center axis”) that passes through the intersection point of the two diagonal lines of the cell and that is vertical to the cell arrangement plane. In other words, the surface of each cell has a vertex on the cell center axis and a plane-symmetrical shape in the horizontal direction and the vertical direction.

In the projection display device, it is desirable to reduce light loss so that a bright image can be displayed. Thus, in order to ensure that as much light as possible that is transmitted through the first fly eye lens enters the second eye lens, each cell of the second eye lens may be formed larger than the corresponding cell of the first eye lens. In such a projection display device, the light that is transmitted through each cell of the first fly eye lens must accurately enter the corresponding cell of the second fly eye lens.

This necessitates changing the traveling direction of the light that enters each cell of the first fly eye lens to the direction of the corresponding cell of the second fly eye lens. This configuration can be achieved by making each cell eccentric. In this case, eccentricity means shifting the position of the spherical center of the surface of each cell of the first fly eye lens from the cell center axis of each cell.

FIGS. 2 and 3 show the surface of the first fly eye lens where each cell is made eccentric. Hereinafter, the amount of shifting of the position of the spherical center of the surface of each cell from the cell center axis of each cell is referred to as an “eccentric amount”. Each cell of the second fly eye lens that makes a pair with the first fly eye lens shown in FIG. 2 is larger in the horizontal direction than the corresponding cell of the first fly eye lens. Each cell of the second fly eye lens that makes a pair with the first fly eye lens shown in FIG. 3 is larger in the horizontal direction and the vertical direction than the corresponding cell of the first fly eye lens.

Each cell of the first fly eye lens shown in FIG. 2 is made eccentric from the inside to the outside in the horizontal direction. The eccentric amount of each cell of this first fly eye lens becomes gradually larger from the cell closest to the cell center axis to the outside in the horizontal direction. The eccentric amounts of the cells in the same column are equal to each other. The eccentric amount of each cell is determined according to the size or the like of the second fly eye lens.

In this first fly eye lens, since each cell is made eccentric from the inside to the outside in the horizontal direction, the traveling direction of the light that enters to each cell changes outward in the horizontal direction according to the eccentric amount of each cell. Thus, the light transmitted through each cell of the first fly eye lens is output to the corresponding cell of the second fly eye lens. As a result, light output from each cell of the first fly eye lens accurately enters the corresponding cell of the second fly eye lens.

Each cell of the first fly eye lens shown in FIG. 3 is made eccentric from the inside to the outside in the horizontal direction and the vertical direction. The eccentric amount of each cell of this first fly eye lens becomes gradually larger from the cell closest to the cell center axis to the outside. The eccentric amounts in the vertical direction of the cells in the same row are equal to each other, and the eccentric amounts in the horizontal direction of the cells in the same column are equal to each other. The eccentric amount of each cell is determined according to the size or the like of the second fly eye lens.

In this first fly eye lens, since each cell is made eccentric from the inside to the outside in the horizontal direction and the vertical direction, the traveling direction of the light that enters each cell changes outward in the horizontal direction and the vertical direction according to the eccentric amount of each cell. Thus, light transmitted through each cell of the first fly eye lens is output to the corresponding cell of the second fly eye lens. As a result, light output from each cell of the first fly eye lens accurately enters the corresponding cell of the second fly eye lens.

Patent Literature 1 and Patent Literature 2 describe technologies of making each cell of the fly eye lens eccentric.

### CITATION LIST

### Patent Literature

Patent Literature 1: JP2000-140261A

Patent Literature 2: JP10-115870A

### SUMMARY OF INVENTION

### Problems to be Solved by Invention

FIG. 4 is a sectional view cut along the line A-A′ of the fly eye lens shown in FIG. 1. FIG. 5 is a sectional view cut along the line B-B′ of the fly eye lens shown in FIG. 2.

In the fly eye lens shown in FIG. 1 where each cell is not eccentric, no step is generated on the boundary between the cells as shown in FIG. 4. However, in the fly eye lens shown in FIG. 2 where each cell is eccentric, a step is generated on the boundary between the cells as shown in FIG. 5.

The fly eye lens is generally made of glass. To form the fly eye lens, a dedicated mold based on its shape is prepared. The mold is generally prepared by cutting.

Thus, in the mold for the fly eye lens, it may be difficult to form a part that corresponds to the step on the boundary between the cells into an accurate shape. In such a case, the boundary between the cells of the fly eye lens is not formed into a shape as designed. This causes shape defects to easily occur on the boundary between the cells of the fly eye lens where the step is generated on the boundary between the cells.

In the projection display device that uses the first fly eye lens in which each cell has a shape defect, the light emitted from the light source is neither normally transmitted through the defective part nor does the light enter the corresponding cell of the second fly eye lens. As a result, in an image projected by the projection display device, the defective part of the first fly eye lens appears as a shadow.

Thus, the outer edge of the image projected by the projection display device that uses the first fly eye lens that has the step on the boundary between the cells is likely to become dark.

In the fly eye lens shown in FIG. 3, steps are generated not only on the boundary between the cells adjacent to each other in the horizontal direction but also on the boundary between the cells adjacent to each other in the vertical direction, and the steps on the boundaries between the cells are larger than those in the case of the fly eye lens shown in FIG. 2. As the step on the boundary between the cells is larger, the shape defect on the boundary between the cells is larger, thus enlarging an area where the outer edge of the mage projected by the projection display device is dark.

### Solution to Problems

The present invention provides a fly eye lens that includes a plurality of cells arranged on a first plane. The plurality of cells includes a pair of cells adjacent to each other, which have spherical centers on a second plane parallel to the first plane and parts of spherical surfaces different from each other in spherical radius as surfaces. The pair of cells satisfies the following relationship, where R_{I} is a spherical radius of the surface of one of the cells, R_{O} is a spherical radius of the surface of the other cell, L_{I} is a distance between the spherical center of the surface of one of the cells and a boundary surface between the pair of cells, and L_{O} is a distance between the spherical center of the surface of the other cell and the boundary surface.

R_{O}=\sqrt{R_{I}²−L_{I}²+L_{O}²} [Expression 1]

### BRIEF DESCRIPTION OF DRAWINGS

FIG. 1 shows the surface of a general fly eye lens.

FIG. 2 shows the surface of a general fly eye lens.

FIG. 3 shows the surface of a general fly eye lens.

FIG. 4 is a sectional view cut along the line A-A′ of the fly eye lens shown in FIG. 1.

FIG. 5 is a sectional view cut along the line B-B′ of the fly eye lens shown in FIG. 2.

FIG. 6 shows the surface of a fly eye lens according to the first embodiment of the present invention.

FIG. 7 is an enlarged view of a portion surrounded with a dashed line shown in FIG. 6.

FIG. 8A is a sectional view cut along the line D-D′ shown in FIG. 7.

FIG. 8B is a sectional view cut along the line E-E′ shown in FIG. 7.

FIG. 9 is a partially enlarged view of FIG. 8A.

FIG. 10A shows a step between cells adjacent to each other in a horizontal direction in the fly eye lens shown in FIG. 7.

FIG. 10B shows a step between cells adjacent to each other in a vertical direction in the fly eye lens shown in FIG. 7.

FIG. 11 shows the surface of a fly eye lens according to Comparative Example 1.

FIG. 12A is a sectional view cut along the line F-F′ shown in FIG. 11.

FIG. 12B is a sectional view cut along the line G-G′ shown in FIG. 11.

FIG. 13A shows a step between cells adjacent to each other in a horizontal direction in the fly eye lens shown in FIG. 11.

FIG. 13B shows a step between cells adjacent to each other in a vertical direction in the fly eye lens shown in FIG. 11.

FIG. 14 shows the surface of a fly eye lens according to the second embodiment of the present invention.

FIG. 15A is a sectional view cut along the line H-H′ shown in FIG. 14.

FIG. 15B is a sectional view cut along the line I-I′ shown in FIG. 14.

FIG. 16 is a partially enlarged view of FIG. 15A.

FIG. 17A shows a step between cells adjacent to each other in a horizontal direction in the fly eye lens shown in FIG. 14.

FIG. 17B shows a step between cells adjacent to each other in a vertical direction in the fly eye lens shown in FIG. 14.

FIG. 18 shows the surface of a fly eye lens according to Comparative Example 2.

FIG. 19A is a sectional view cut along the line J-J′ shown in FIG. 18.

FIG. 19B is a sectional view cut along the line K-K′ shown in FIG. 18.

FIG. 20A shows a step between cells adjacent to each other in a horizontal direction in the fly eye lens shown in FIG. 18.

FIG. 20B shows a step between cells adjacent to each other in a vertical direction in the fly eye lens shown in FIG. 18.

FIG. 21 shows the surface of a fly eye lens according to Comparative Example 3.

FIG. 22A shows a step between cells adjacent to each other in a horizontal direction in the fly eye lens shown in FIG. 21.

FIG. 22B shows a step between cells adjacent to each other in a vertical direction in the fly eye lens shown in FIG. 21.

FIG. 23 schematically shows the configuration of a projection display device according to the third embodiment of the present invention.

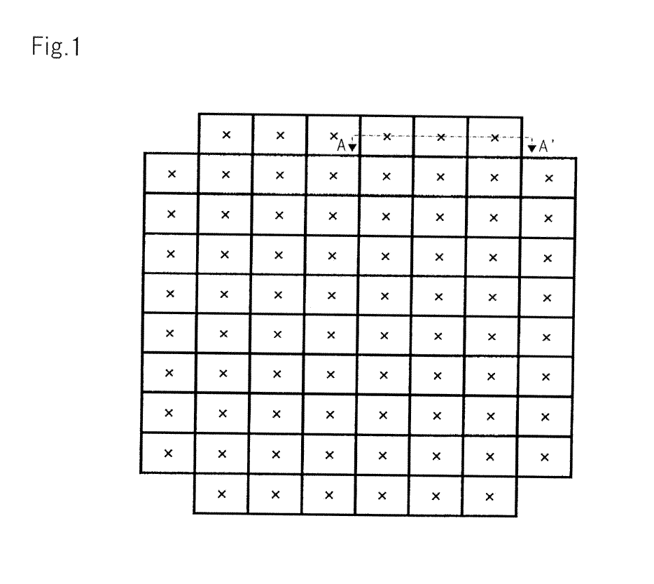

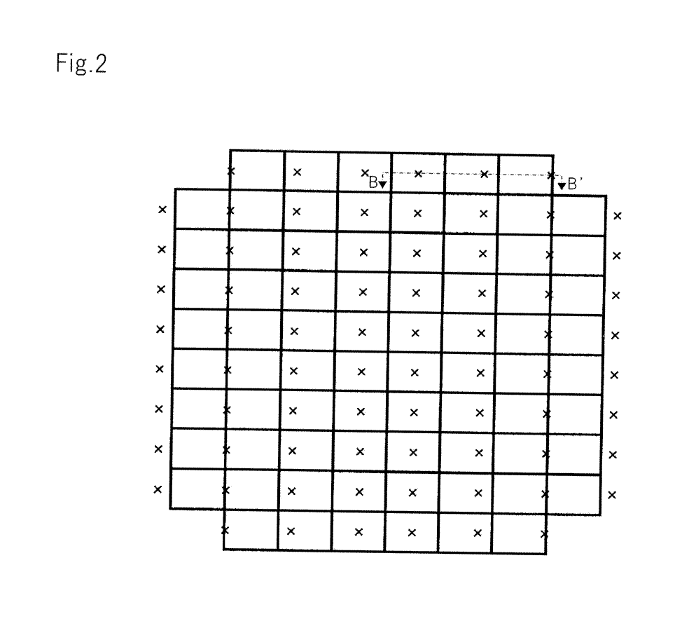

### DESCRIPTION OF EMBODIMENTS

### First Embodiment

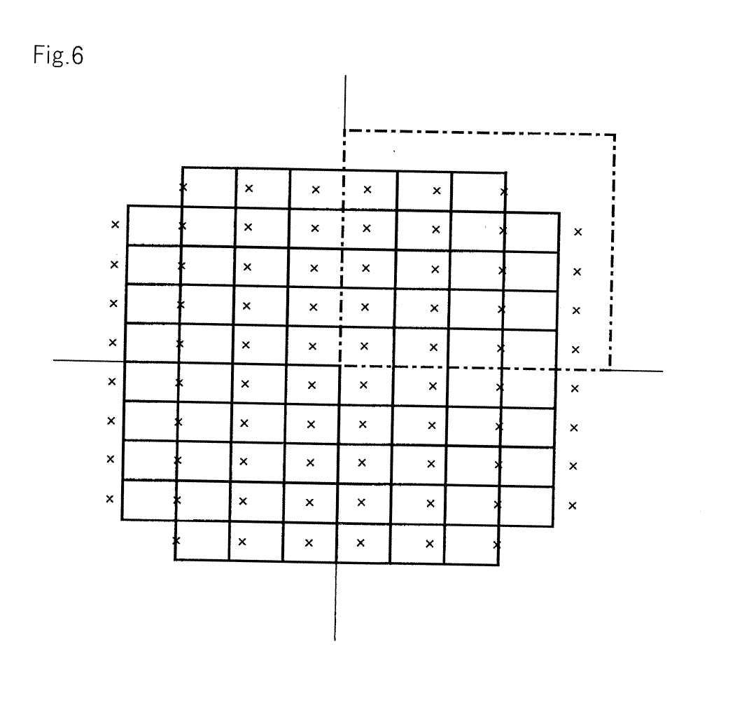

FIG. 6 shows the surface of a fly eye lens according to the first embodiment of the present invention. This fly eye lens is formed to be symmetrical in a horizontal direction and a vertical direction. Thus, in this embodiment, an upper right portion surrounded with a dashed line corresponding to ¼ of the fly eye lens shown in FIG. 6 is described.

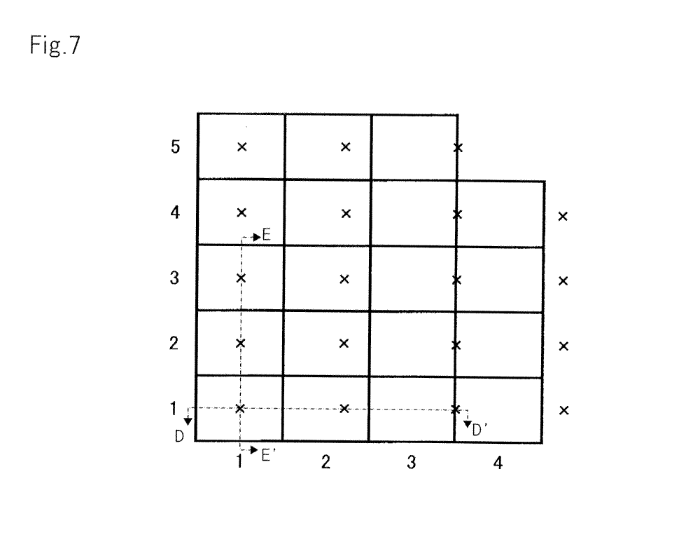

FIG. 7 is an enlarged view of the portion surrounded with the dashed line in the fly eye lens of this embodiment shown in FIG. 6. As shown in FIG. 7, numerals of 1 to 5 are allocated to the cell rows of the fly eye lens in order from the inside to the outside in the vertical direction. Numerals of 1 to 4 are allocated to the cell columns of the fly eye lens in order from the inside to the outside in the horizontal direction. The cell of an on row and an n column is represented by Cmn.

Specifically, a center cell in the horizontal direction and the vertical direction in the fly eye lens is C11. Cells in the same first row as that of cell C11 are C12, C13, and C14 in order from the C11 to the outside of the horizontal direction. Second to fifth rows are similar to the first row. Cells in the same first column as that of cell C11 are C21, C31, C41, and C51 in order from the C11 to the outside of the vertical direction. Second to fourth columns are similar to the first row.

Each cell of the fly eye lens is made eccentric outside in the horizontal direction. The eccentric amounts of the cells in the same column are equal to one another, and the eccentric amounts are larger in the cells of the outside column. Each cell is not made eccentric in the vertical direction.

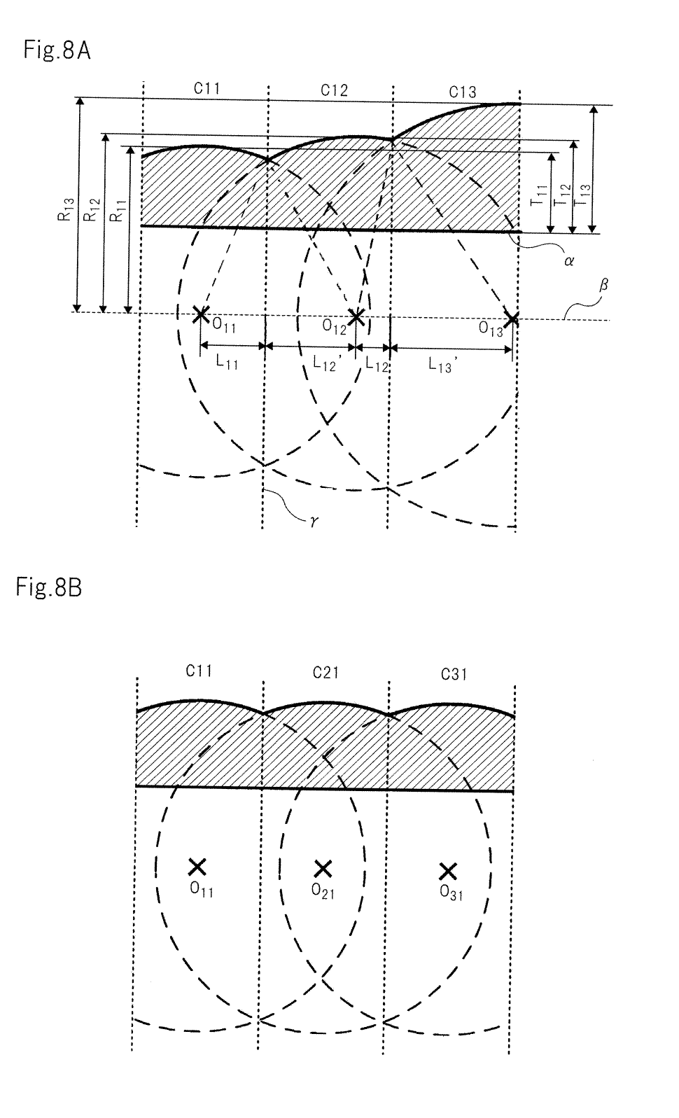

FIG. 8A is a sectional view cut along the line D-D′ shown in FIG. 7. FIG. 8B is a sectional view cut along the line E-E′ shown in FIG. 7. The spherical centers O of the surfaces of the cells of both cases are located on plane β parallel to cell arrangement plane a.

As shown in FIG. 8A, in the fly eye lens, the radius R of a spherical surface (hereinafter, “spherical radius R”) defining the shape of the surface of the cell is larger in the cell of the outside column. As shown in FIG. 8B, the spherical radiuses of cells in the same column are equal to each other.

In the fly eye lens according to this embodiment, generation of steps on the boundaries between the cells is prevented by determining the spherical radius R of the surface of each cell by a method described below.

According to this embodiment, first, the spherical radius R of the surface of cell C11 and the eccentric amounts of the cells in each column are determined according to the size or the like of a second fly eye lens that makes a pair with this fly eye lens. Specifically, the spherical radius R of the surface of cell C11 is determined according to the focal length of each cell, and the eccentric amounts of the cells in each column are determined according to the changing amount of the traveling direction of light entered to each cell.

The spherical radius of the surface of cell Cmn is represented by Rₘₙ, and the spherical center of the surface of cell Cmn is represented by Oₘₙ. A distance from the spherical center Oₘₙ of the surface of cell Cmn to a plane that becomes a boundary between cell Cmn and cell Cm(n+1) is represented by Lₘₙ. A distance from the spherical center Oₘₙ of the surface of cell Cmn to a plane that becomes a boundary between cell Cmn and cell Cm(n−1) is represented by Lₘₙ′.

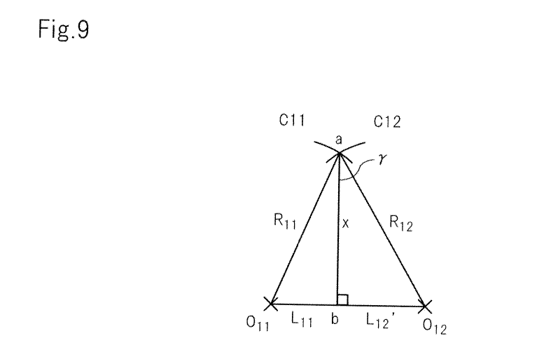

Referring to FIG. 9, a method for calculating the spherical radius R₁₂ of the surface of cell C12 is described. FIG. 9 is a partially enlarged view of FIG. 8A. A surface that becomes a boundary surface between cells C11 and C12 is set as a boundary surface y. An intersection point on this section between the boundary surface y and the surface of the fly eye lens is set as a point a, and an intersection point between the boundary surface y and line segment O11 O12 is set as a point b. A line segment ab has a length x.

Thus, L₁₁ is a length of the line segment O₁₁b, and L₁₂′ is a length of the line segment bO₁₂. Since the positions of O₁₁ and O₁₂ are determined based on the eccentric amounts of cells C11 and C12, values of L₁, and L₁₂′ are calculated from the eccentric amounts of cells C II and C12.

FIG. 9 shows two right triangles abO₁₁ and abO₁₂. When the Pythagorean theorem is applied to these right triangles, the following two expressions are established.

R₁₁²−L₁₁²=x²

R₁₂²−L₁₂′²=x²

The right-hand sides of these two expressions are both x², while the left-hand sides of the two expressions are equal. The following expression can accordingly be acquired.

R₁₁²−L₁₁²=R₁₂²−L₁₂′²

When this expression is modified, R₁₂ is represented by the following expression.

R₁₂=\sqrt{R₁₁²−L₁₁²+L₁₂′²} [Expression 2]

Similarly, the spherical surface R₁₃ of cell C13 and the spherical surface R₁₄ of cell C14 are sequentially calculated.

R₁₃=\sqrt{R₁₂²−L₁₂²+L₁₃′²}

R₁₄=\sqrt{R₁₃²−L₁₃²+L₁₄′²} [Expression 3]

The spherical radiuses R₂₁ to R₅₁ of the surfaces of cells C21 to C51 in the same first column as that of cell C11 are equal to the spherical surface R₁₁ of the surface of cell C11, and the spherical radiuses R₂₂ to R₅₂ of the surfaces of cells C22 to C52 in the same second column as that of cell C12 are equal to the spherical surface R₁₂ of the surface of cell C12. The spherical radiuses R₂₃ to R₅₃ of the surfaces of cells C23 to C53 in the same third column as that of cell C13 are equal to the spherical surface R₁₃ of the surface of cell C13, and the spherical radiuses R₂₄ to R₄₄ of the surfaces of cells C24 to C44 in the same fourth column as that of cell C14 are equal to the spherical surface R₁₄ of the surface of cell C14.

Thus, when the spherical radius R₁₁ of the surface of cell C11 and the eccentric amount of each cell are determined, the spherical radiuses R of the surfaces of all the cells are determined.

In short, in the fly eye lens according to this embodiment, a given pair of cells adjacent to each other in the horizontal direction satisfies the relationship of the following formula (1).

[Expression 4]

R_{O1}=\sqrt{R_{I1}²−L_{I1}²+L_{O1}′²} (1)

R_{I1} is a spherical radius of the surface of an inner cell of the pair of cells, and L_{I1} is a distance between the spherical center O of the surface of the inner cell and the boundary surface between the pair of cells. R_{O1} is a spherical radius of the surface of an outer cell of the pair of cells, and L_{O1} is a distance between the spherical center O of the surface of the outer cell and the boundary surface between the pair of cells.

The formula (1) can be applied to a fly eye lens that includes the cells of all row and column numbers. Further, the formula (1) can be applied not only to the fly eye lens of this embodiment that includes the cells made eccentric outside in the horizontal direction but also to a fly eye lens that includes cells made eccentric inside in the horizontal direction.

Different from the case of the fly eye lens according to this embodiment, it is not essential for a given pair of cells adjacent to each other in the horizontal direction to satisfy the relationship of the formula (1). Even when only one of the two cells adjacent to each other in the horizontal direction satisfies the relationship of the formula (1), the influence of steps in the boundaries between the cells in the entire fly eye lens can be reduced.

Concerning the thickness T of each cell of the fly eye lens, when the thickness T₁₁ of cell C11 is determined, the thicknesses T₁₂ to T₁₄ of cells C12 to C14 in the same first row as that of cell C11 are sequentially calculated.

T₁₂=T₁₁+R₁₂−R₁₁

T₁₃=T₁₂+R₁₃−R₁₂

T₁₄=T₁₃+R₁₄−R₁₃

The thicknesses T₂₁ to T₅₁ of cells C21 to C51 in the same first row as that of cell C11 are equal to the thickness T₁₁ of cell C11, and the thicknesses T₂₂ to T₅₂ of cells C22 to C52 in the same second row as that of cell C12 are equal to the thickness T₁₂ of cell C12. The thicknesses T₂₃ to T₅₃ of cells C23 to C53 in the same third row as that of cell C13 are equal to the thickness T₁₃ of cell C13, and the thicknesses T₂₄ to T₅₄ of cells C24 to C44 in the same fourth row as that of cell C14 are equal to the thickness T₁₄ of cell C14.

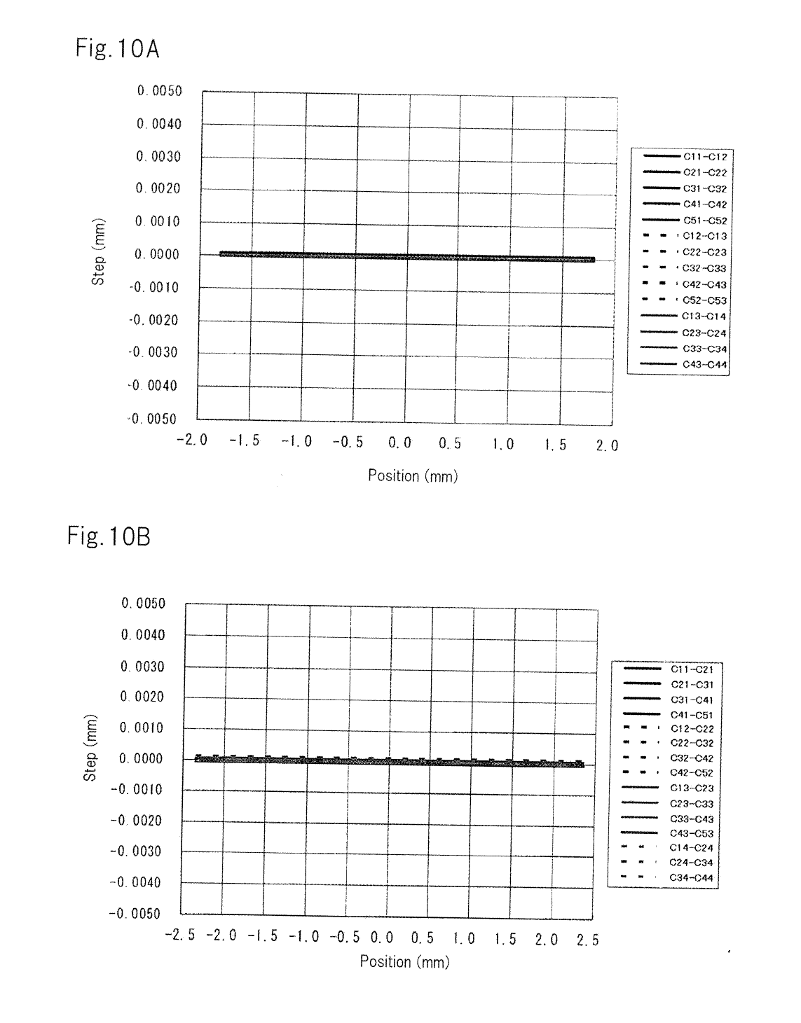

The steps in the boundaries between the cells in the fly eye lens according to this embodiment were measured. FIG. 10A shows the step in the boundary between the cells adjacent to each other in the horizontal direction, and FIG. 10B shows the step in the boundary between the cells adjacent to each other in the vertical direction.

In FIGS. 10A and 10B, a vertical axis indicates the steps in the boundaries between the cells, and a horizontal axis indicates positions corresponding to the data of the steps. The position “0.0 mm” of the horizontal axis is the center of each boundary, and the absolute values of the horizontal axis indicate distances from the center of each boundary. For example, a position “1.5 mm” is away by 1.5 millimeters from the center of the boundary, and a position “−1.0 mm” is away by 1.0 millimeter from the center of the boundary in a direction opposite that of the position “1.5 mm”.

For example, the data of the boundary between cells C11 and C12 is represented by C11-C12, and the data of the boundary between cells C11 and C21 is represented by C11-C21.

It can be understood from FIGS. 10A and 10B that no step is generated in any boundary between the cells in the fly eye lens of this embodiment.

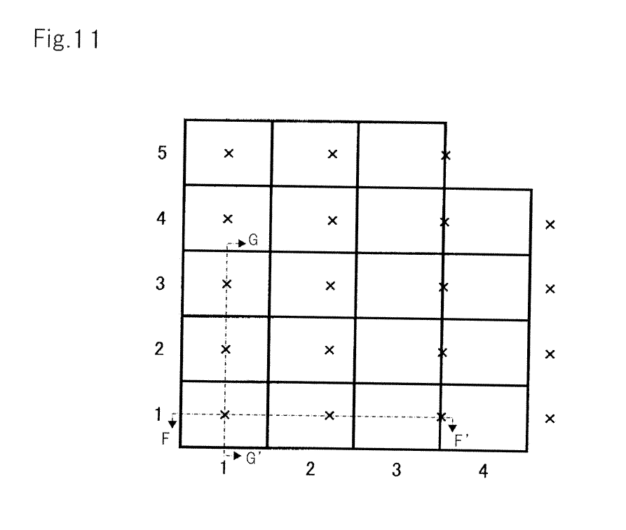

FIG. 11 shows the surface of a fly eye lens according to Comparative Example 1. The size and the eccentric amount of each cell of this fly eye lens are equal to those of the fly eye lens of the embodiment shown in FIG. 7. The spherical radiuses of the surfaces of all the cells of this fly eye lens are equal to one another.

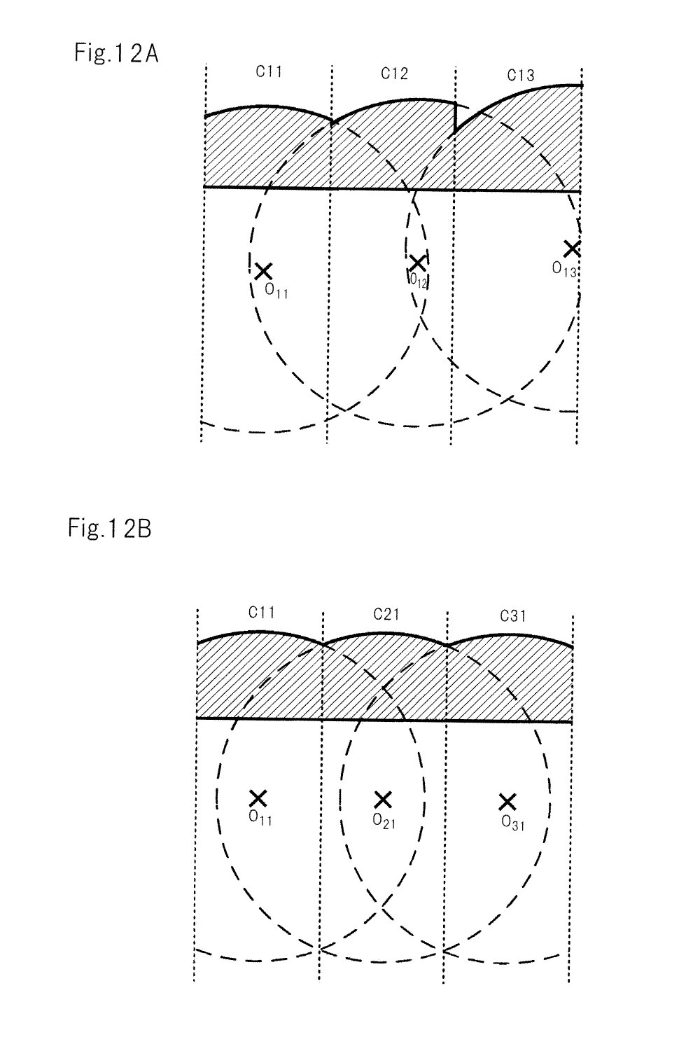

FIG. 12A is a sectional view cut along the line F-F′ shown in FIG. 11. FIG. 12B is a sectional view cut along the line G-G′ shown in FIG. 11. In this fly eye lens, the thickness of each cell is adjusted no that the maximum value of steps in the boundaries between the cells can be smallest.

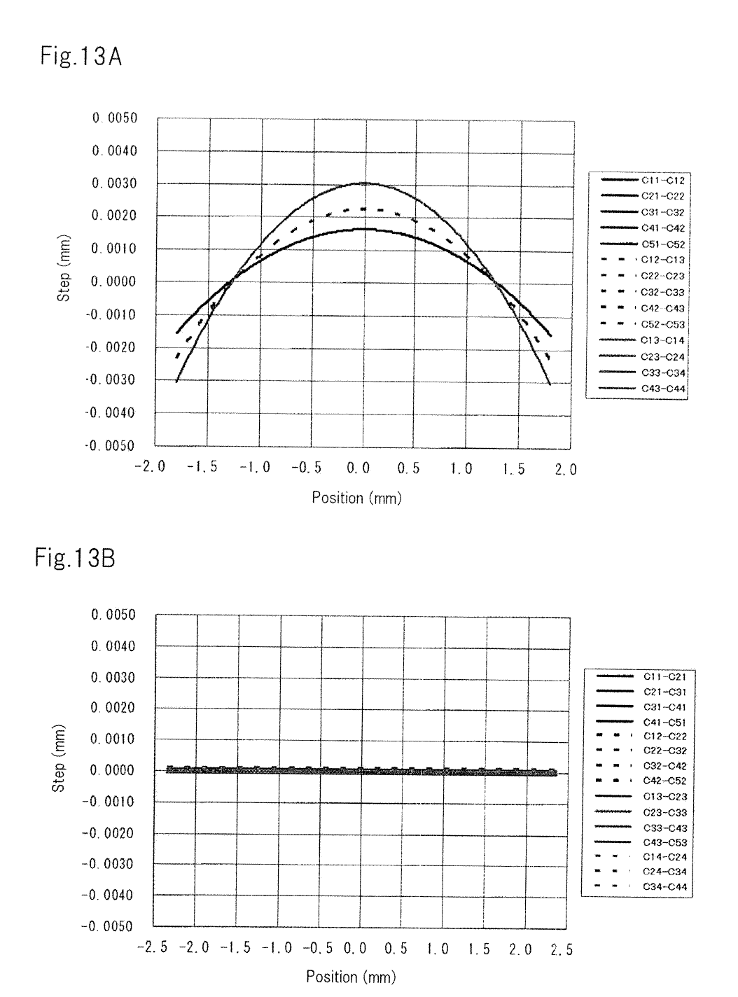

The steps in the boundaries between the cells in the fly eye lens according to Comparative Example 1 were measured. FIG. 13A shows a step in the boundary between the cells adjacent to each other in a horizontal direction, and FIG. 13B shows a step in the boundary between the cells adjacent to each other in a vertical direction.

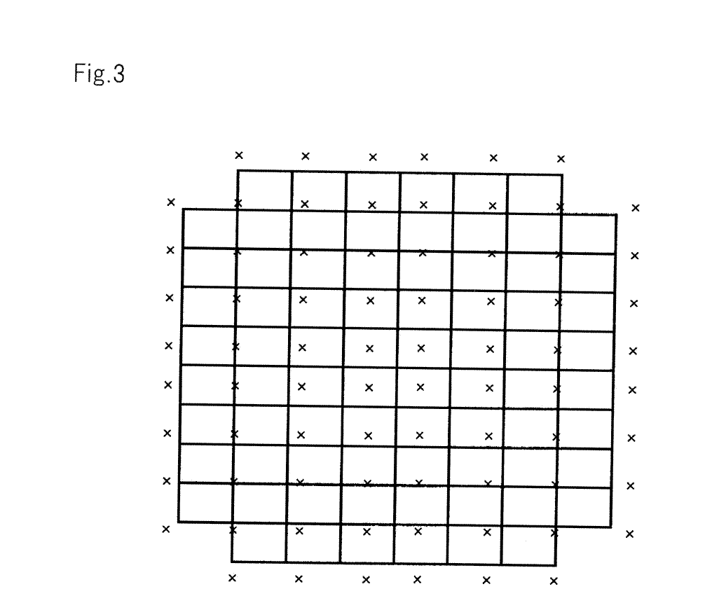

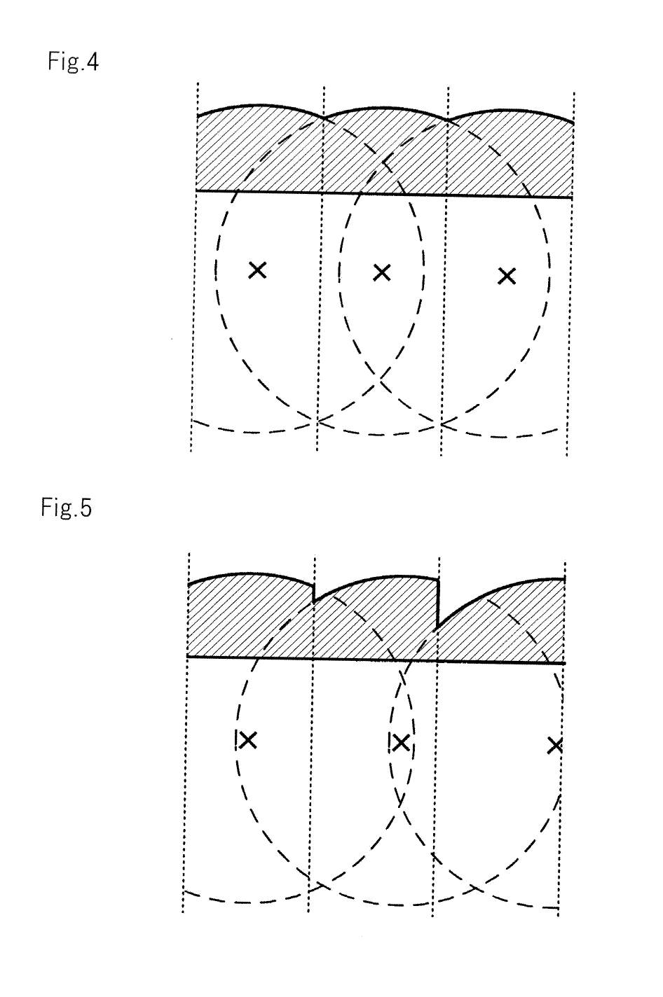

In this fly eye lens, each cell is not made eccentric in the vertical direction, and hence no step is generated in the boundary between the cells adjacent to each other in the vertical direction as shown in FIG. 3B. However, as shown in FIG. 13A, a step up to about 30 micrometers is generated in the boundary between the cells adjacent to each other in the horizontal direction.

### Second Embodiment

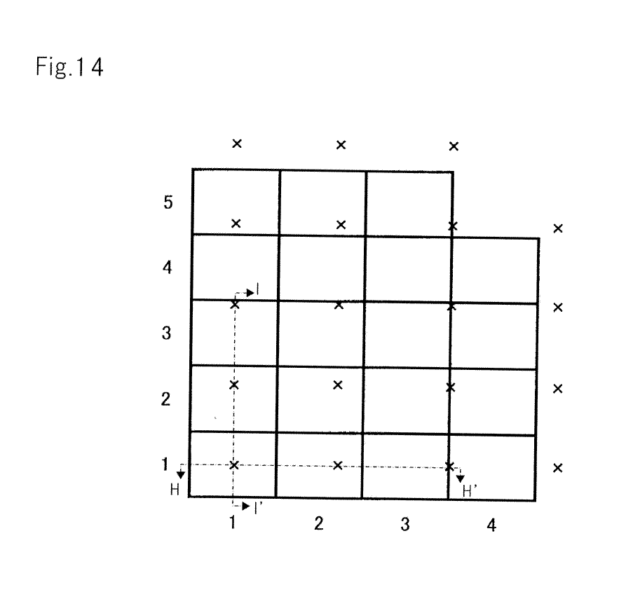

FIG. 14 shows the surface of a fly eye lens according to the second embodiment of the present invention. The cells of the fly eye lens according to this embodiment are made eccentric outside not only in a horizontal direction but also a vertical direction. The eccentric amounts of the cells in the same column in the horizontal direction are equal to one another, and eccentric amounts in the horizontal direction are larger in the cells in the outside column. The eccentric amounts of the cells in the same row in the vertical direction are equal to one another, and eccentric amounts in the vertical direction are larger in the cells in the outside row.

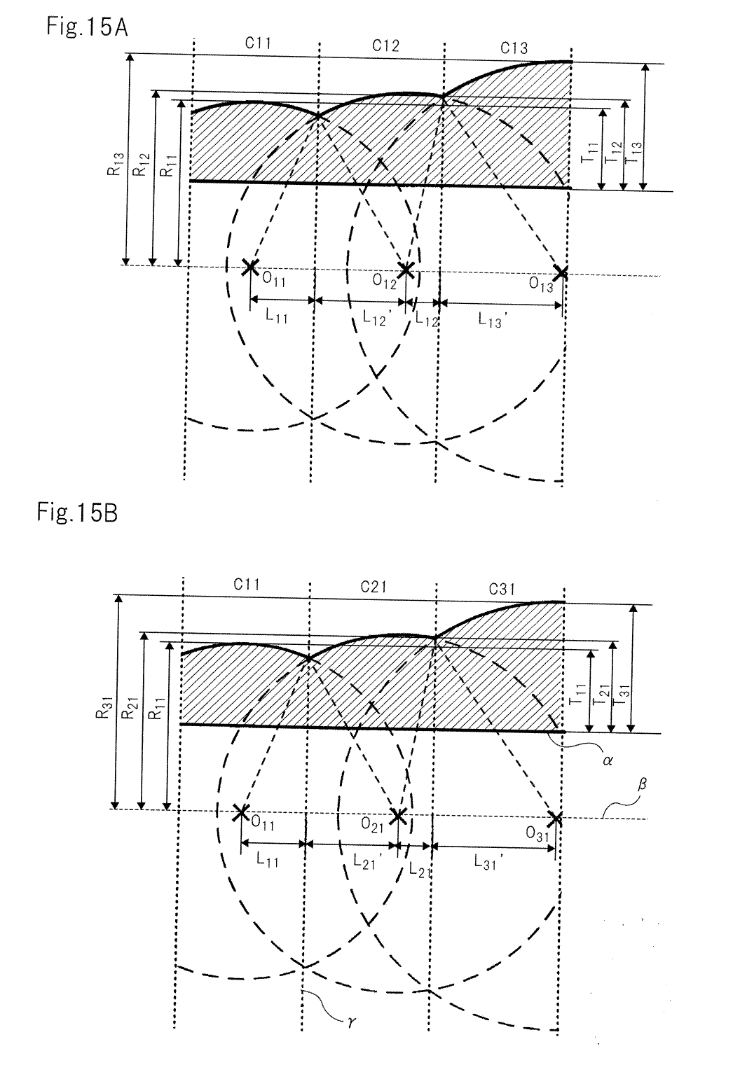

FIG. 15A is a sectional view cut along the line H-H′ shown in FIG. 14, and FIG. 15B is a sectional view cut along the line I-I′ shown in FIG. 14. The spherical centers O of the surfaces of all the cells are located on plane β parallel to cell arrangement plane α.

As shown in FIG. 15A, the spherical radiuses R of the surfaces of given cells in the same row are larger in the cells in the outside column. As shown in FIG. 15B, the spherical radiuses R of the surfaces of given cells in the same column are larger in the cells in the outside row.

In the fly eye lens according to this embodiment, generation of steps in the boundaries between the cells can be prevented by determining the radius R of the surface of each cell by a method described below.

According to this embodiment, first, the spherical radius R₁₁ of the surface of cell C11, the eccentric amounts of the cells in each column in the horizontal direction, and the eccentric amounts of the cells in each row in the vertical direction are determined according to the size or the like of a second fly eye lens that makes a pair with this fly eye lens. Specifically, the spherical radius R of the surface of cell C11 is determined according to the focal length of each cell, and the eccentric amounts of the cells in each column and the eccentric amounts of the cells in each row in the vertical direction are determined according to the changing amount of the traveling direction of light entered to each cell.

Based on the spherical radius R₁₁ of the surface of cell C11, the eccentric amounts of the cells in each column in the horizontal direction, and the eccentric amounts of the cells in each row in the vertical direction, the radiuses R of the surfaces of the cells other than cell C11 are calculated by a method described below.

First, the spherical radiuses R₁₂ to R₁₄ of the surfaces of cells C12 to C14 in the first row are calculated by the same method as that of the first embodiment.

R₁₂=\sqrt{R₁₁²−L₁₁²+L₁₂′²}

R₁₃=\sqrt{R₁₂²−L₁₂²+L₁₃′²}

R₁₄=\sqrt{R₁₃²−L₁₃²+L₁₄′²} [Expression 5]

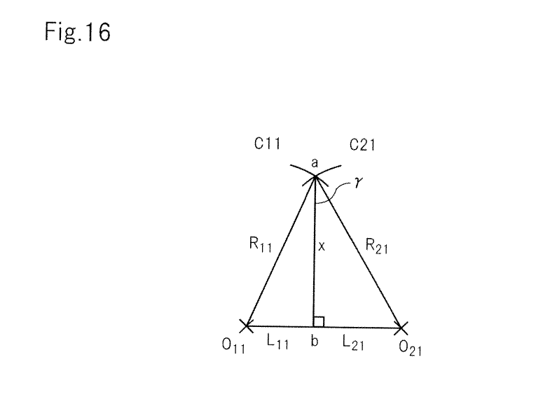

Referring to FIG. 16, a method for calculating the spherical radius R₂₁ of the surface of cell C21 is described. FIG. 16 is a partially enlarged view of FIG. 15B. A surface that becomes a boundary between cells C11 and C21 is set as a boundary surface y. An intersection point on this section between the boundary surface y and the surface of the fly eye lens is set as a point a, and an intersection point between the boundary surface y and line segment O11 O12 is set as a point b. A line segment ab has a length x.

FIG. 16 shows two right triangles abO₁₁ and abO21. When the Pythagorean theorem is applied to these right triangles as in the case of the first embodiment, the following expression is established.

R₁₁²=L₁₁²=R₂₁²−L₂₁′²

When this expression is modified, R₂₁ is represented by the following expression.

R₂₁=\sqrt{R₁₁²−L₁₁²+L₂₁′²} [Expression 6]

Similarly, the spherical surfaces R₃₁ to R₅₁ of the surfaces of cells C31 to C51 are sequentially calculated.

R₃₁=\sqrt{R₂₁²−L₂₁²+L₃₁′²}

R₄₁=\sqrt{R₃₁²−L₃₁²+L₄₁′²}

R₅₁=\sqrt{R₄₁²−L₄₁²+L₅₁′²} [Expression 7]

As in the case of the cells in the first column, the radiuses R of the surfaces of the cells in the second row and after of the second to fourth columns are calculated as follows.

R₂₂=\sqrt{R₁₂²−L₁₂²+L₂₂′²}

R₃₂=\sqrt{R₂₂²−L₂₂²+L₃₂′²}

R₄₂=\sqrt{R₃₂²−L₃₂²+L₄₂′²}

R₅₂=\sqrt{R₄₂²−L₄₂²+L₅₂′²}

R₂₃=\sqrt{R₁₃²−L₁₃²+L₂₃′²}

R₃₃=\sqrt{R₂₃²−L₂₃²+L₃₃′²}

R₄₃=\sqrt{R₃₃²−L₃₃²+L₄₃′²}

R₅₃=\sqrt{R₄₃²−L₄₃²+L₅₃′²}

R₂₄=\sqrt{R₁₄²−L₁₄²+L₂₄′²}

R₃₄=\sqrt{R₂₄²−L₂₄²+L₃₄′²}

R₄₄=\sqrt{R₃₄²−L₃₄²+L₄₄′²} [Expression 8]

Thus, when the spherical radius R₁₁ of the surface of cell C11 and the eccentric amount of each cell are determined, the spherical radiuses R of the surfaces of all the cells are determined.

In short, in the fly eye lens according to this embodiment, as in the case of the fly eye lens of the first embodiment, a given pair of cells adjacent to each other in the horizontal direction satisfies the relationship of the following formula (2).

[Expression 9]

R_{O1}=\sqrt{R_{I1}²−L_{I1}²+L_{O1}²} (2)

Further, in the fly eye lens according to this embodiment, a given pair of cells adjacent to each other in the vertical direction satisfies the relationship of the following formula (3).

[Expression 10]

R_{O2}=\sqrt{R_{I2}²−L_{I2}²+L_{O2}²} (3)

R₁₂ is the spherical radius of the surface of the inner cell of the pair of cells adjacent to each other in the vertical direction, and L₁₂ is the distance between spherical center O of the surface of the inner cell and the boundary surface between the pair of cells. R_{O2} is the spherical radius of the surface of the outer cell of the pair of cells adjacent to each other in the vertical direction, and L_{O2} is the distance between the spherical center O of the surface of the outer cell and the boundary surface between the pair of cells.

The formulas (2) and (3) can be applied to a fly eye lens that includes the cells of all row and column numbers. Further, the formulas (2) and (3) can be applied not only to the fly eye lens of this embodiment that includes the cells made eccentric from the inside to the outside in the horizontal direction and the vertical direction but also to a fly eye lens that includes cells made eccentric from the outside to the inside in the horizontal direction and the vertical direction.

Different from the case of the fly eye lens according to this embodiment, it is not essential for a given pair of cells adjacent to each other in the horizontal direction to satisfy the relationship of formula (2) and for a given pair of cells adjacent to each other in the vertical direction to satisfy the relationship of formula (3). Even when only one of the two cells adjacent to each other in the horizontal direction satisfies the relationship of formula (2) and only one of the two cells adjacent to each other in the vertical direction satisfies the relationship of formula (3), the influence of steps in the boundaries between the cells in the entire fly eye lens can be reduced.

Concerning thickness T of each cell of the fly eye lens, when thickness T₁₁ of cell C11 is determined, thicknesses T₁₂ to T₁₄ of cells C12 to C14 in the same first row as that of cell C11 are sequentially calculated.

T₁₂=T₁₁+R₁₂−R₁₁

T₁₃=T₁₂+R₁₃−R₁₂

T₁₄=T₁₃+R₁₄−R₁₃

Similarly, thicknesses T₂₁ to T₅₁ of cells C21 to C51 in the same first column as that of cell C11 are sequentially calculated.

T₂₁=T₁₁+R₂₁−R₁₁

T₃₁=T₂₁+R₃₁−R₂₁

T₄₁=T₃₁+R₄₁−R₃₁

T₅₁=T₄₁+R₅₁−R₄₁

Further, as in the case of the cells in the first column, thicknesses T of the cells of the second row and after of the second to fourth columns are sequentially calculated.

T₂₂=T₁₂+R₂₂−R₁₂

T₃₂=T₂₂+R₃₂−R₂₂

T₄₂=T₃₂+R₄₂−R₃₂

T₅₂=T₄₂+R₄₂−R₄₂

T₂₃=T₁₃+R₂₃−R₁₃

T₃₃=T₂₃+R₃₃−R₂₃

T₄₃=T₃₃+R₄₃−R₃₃

T₅₃=T₄₃+R₅₃−R₄₃

T₂₄=T₁₄+R₂₄−R₁₄

T₃₄=T₂₄+R₃₄−R₂₄

T₄₄=T₃₄+R₄₄−R₃₄

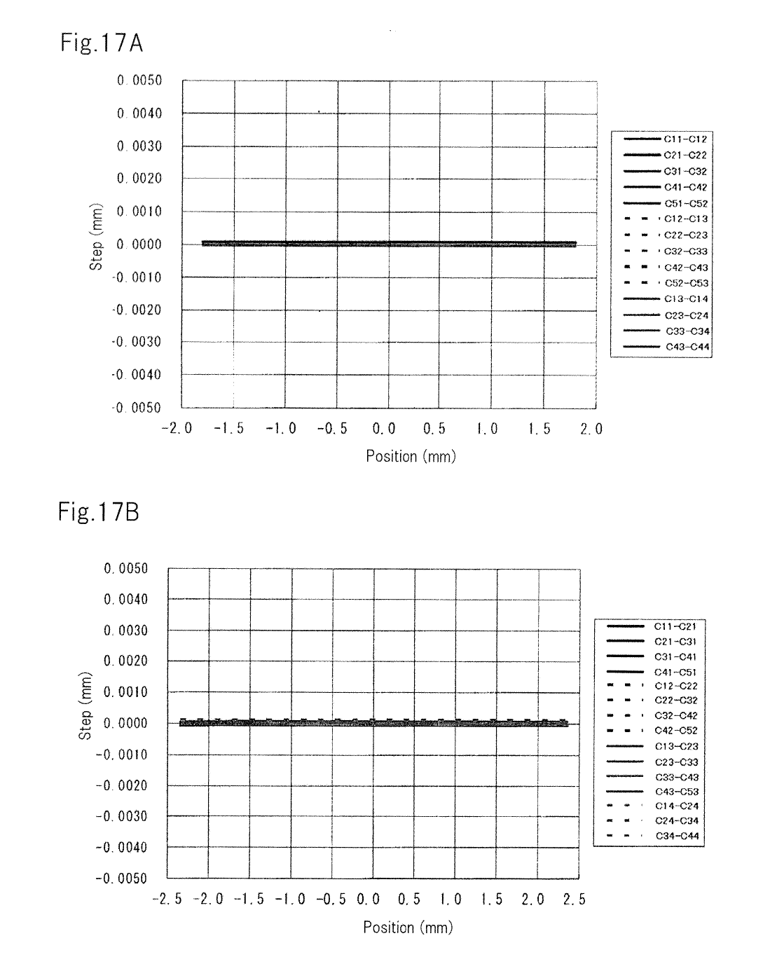

The steps in the boundaries between the cells in the fly eye lens according to this embodiment were measured. FIG. 17A shows the step in the boundary between the cells adjacent to each other in the horizontal direction, and FIG. 17B shows the step in the boundary between the cells adjacent to each other in the vertical direction.

It can be understood from FIGS. 17A and 17B that no step is generated in any boundary between the cells in the fly eye lens of this embodiment.

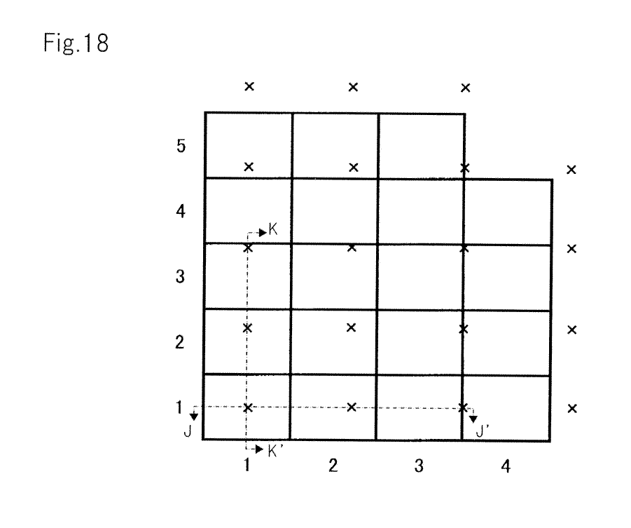

FIG. 18 shows the surface of a fly eye lens according to Comparative Example 2. The size and the eccentric amount of each cell of this fly eye lens are equal to those of the fly eye lens of the embodiment shown in FIG. 14. The spherical radiuses of the surfaces of all the cells of this fly eye lens are equal to one another.

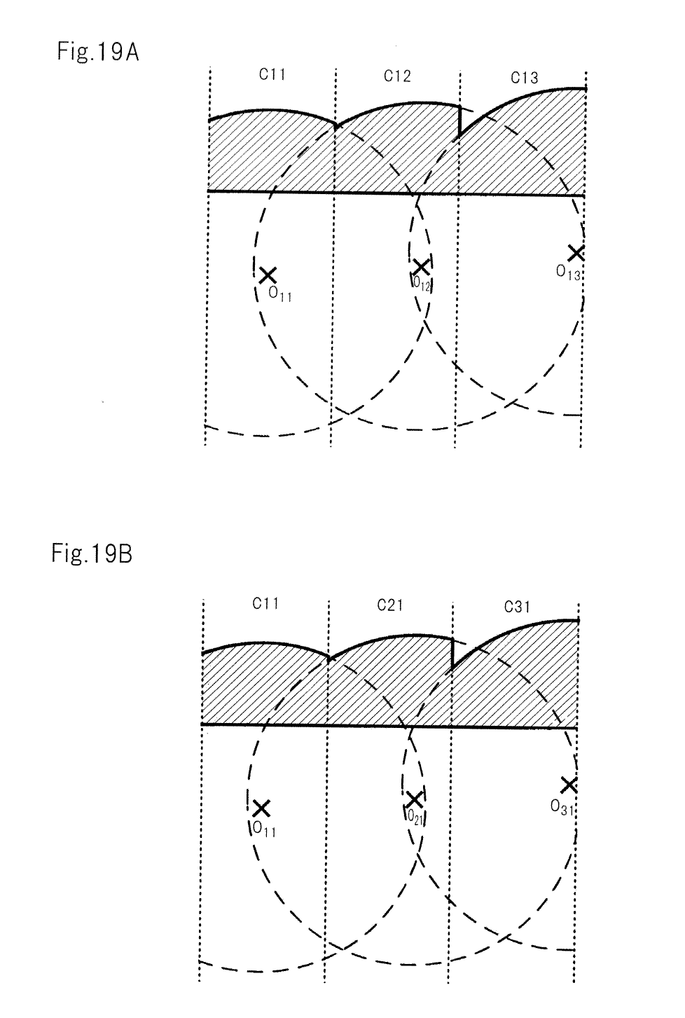

FIG. 19A is a sectional view cut along line J-J′ shown in FIG. 18. FIG. 19B is a sectional view cut along line K-K′ shown in FIG. 18. In this fly eye lens, the thickness of each cell is adjusted so that the maximum value of steps in the boundaries between the cells can be smallest.

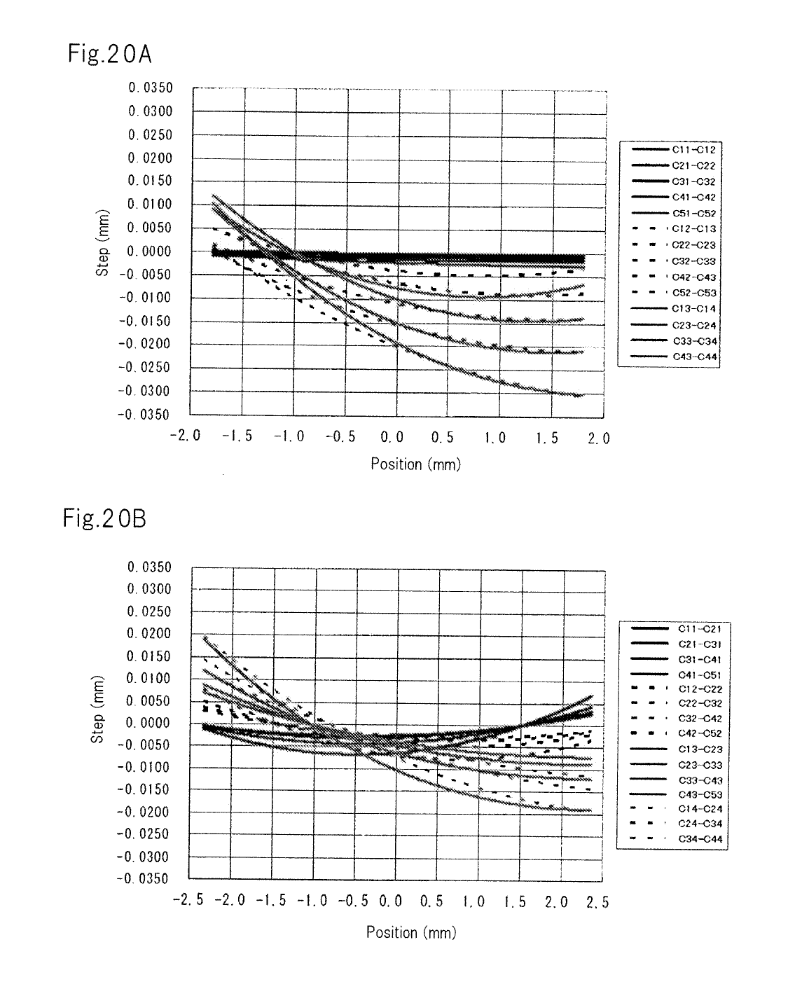

The steps in the boundaries between the cells in the fly eye lens according to Comparative Example 2 were measured. FIG. 20A shows a step in the boundary between the cells adjacent to each other in the horizontal direction, and FIG. 20B shows a step in the boundary between the cells adjacent to each other in the vertical direction.

In this fly eye lens, as shown in FIGS. 20A and 20B, steps are generated both in the boundary between the cells adjacent to each other in the horizontal direction and in the boundary between the cells adjacent to each other in the vertical direction. A step up to about 20 micrometers is generated in the boundary between the cells adjacent to each other in the horizontal direction, and a step up to about 30 micrometers is generated in the boundary between the cells adjacent to each other in the vertical direction.

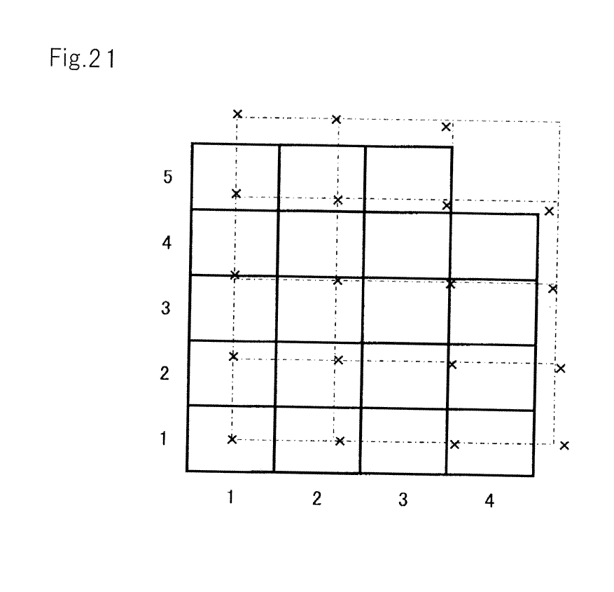

FIG. 21 shows the surface of a fly eye lens according to Comparative Example 3. This fly eye lens is configured by improving the fly eye lens of Comparative Example 2 to reduce the steps in the boundaries between the cells.

FIG. 21 shows grids indicated by dashed lines to define the positions of the spherical centers of the surfaces of the cells of the fly eye lens according to Comparative Example 2 shown in FIG. 18. The spherical centers of the surfaces of the cells of the fly eye lens according to Comparative Example 3 are slightly shifted from the spherical centers of the surfaces of the cells of the fly eye lens according to Comparative Example 2 so that the steps in the boundaries between the cells can be symmetrical. Thus, the steps in the boundaries between the cells can be reduced.

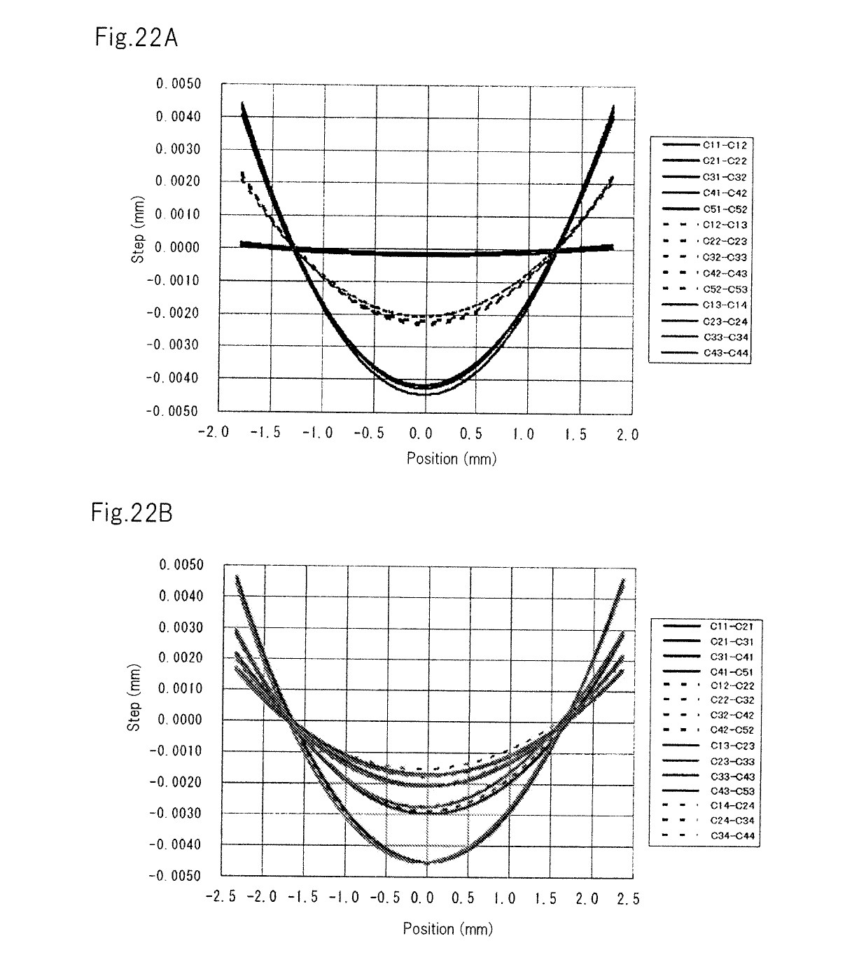

The steps in the boundaries between the cells in the fly eye lens according to Comparative Example 3 were measured. FIG. 22A shows the step in the boundary between the cells adjacent to each other in the horizontal direction, and FIG. 22B shows the step in the boundary between the cells adjacent to each other in the vertical direction.

As shown in FIGS. 22A and 22B, the steps in the boundaries between the cells are symmetrical. Still, however, a step up to about 5 micrometers is generated in the boundary between the cells adjacent to each other in the horizontal direction, and a step up to about 5 micrometers is generated in the boundary between the cells adjacent to each other in the vertical direction.

### Third Embodiment

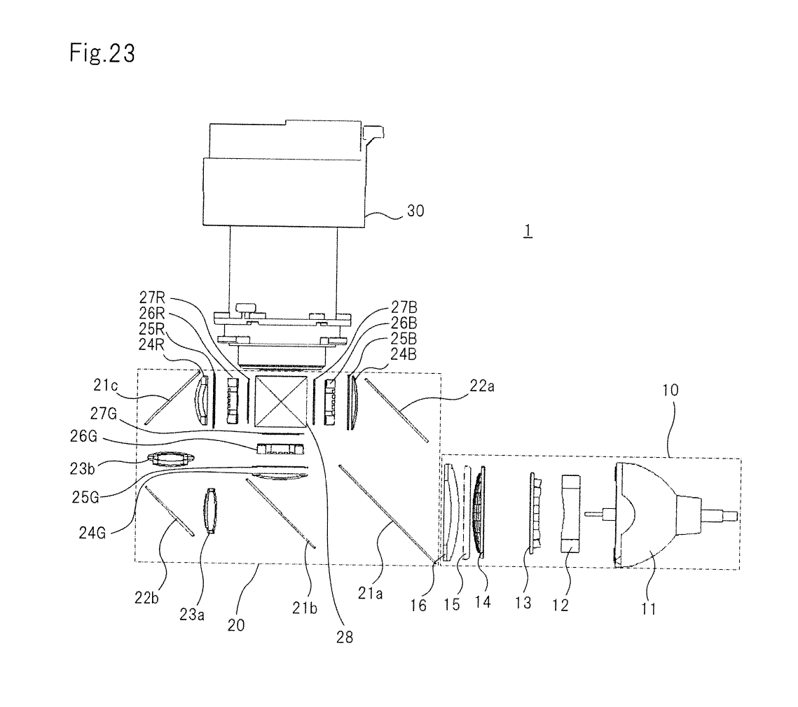

FIG. 23 schematically shows the configuration of projection display device 1 according to the third embodiment of the present invention. Projection display device 1 includes illumination optical unit 10 that emits light, image forming unit 20 that modulates the light emitted from the illumination optical unit based on an image signal, and projection lens 30 that magnifies and projects the light modulated by image forming unit 20 to a screen or the like.

Illumination optical unit 10 includes first fly eye lens 13 according to the first embodiment. First fly eye lens 13 is configured such that the surfaces of the cells are directed to light source 11 side. First fly eye lens 13 constitutes, together with second fly eye lens 14, a uniformizing optical unit that uniformizes the illuminance of the light emitted from light source 11.

Second fly eye lens 14 includes cells corresponding to the cells of first fly eye lens 13. The cells of second fly eye lens 14 are formed slightly larger than the corresponding cells of first fly eye lens 13.

Thus, spherical radius R₁₁ of the surface of cell C11 and the eccentric amounts of the cells of first fly eye lens 13 are determined as described above in the first embodiment so that the light transmitted through each cell can enter the corresponding cells of second fly eye lens 14.

The light emitted from light source 11 and transmitted through concave lens 12 is transmitted through each cell of first fly eye lens 13 to be divided into a plurality of very small light fluxes, and then enters each cell of second fly eye lens 14. The light transmitted through each cell of second fly eye lens 14 is transmitted through polarization conversion element 15 to be converted into polarized light, and then transmitted through condenser lens 16 to enter image forming unit 20.

The light that has entered image forming unit 20 is separated into three primary colors of R, G, and B sequentially by dichroic mirrors 21a and 21b. Specifically, the light of a blue wavelength included in white light is reflected by dichroic mirror 21a, the light of a green wavelength is transmitted through dichroic mirror 21a and then reflected by dichroic mirror 21b, and the light of a red wavelength is transmitted through both dichroic mirrors 21a and 21b.

The blue light reflected by dichroic mirror 21a, which is included in the light applied to illumination optical unit 10, is reflected by reflection mirror 22a, and then sequentially transmitted through field lens 24B, entrance side polarization plate 25B, and liquid crystal light bulb 26B to enter exit side polarization plate 27B. The light transmitted through exit side polarization plate 27B enters cross dichroic mirror 28.

The green light reflected by dichroic mirror 21b is sequentially transmitted through field lens 24G, entrance side polarization plate 25G, and liquid crystal light bulb 26G to enter exit side polarization plate 27G. The light transmitted through exit side polarization plate 27G enters cross dichroic mirror 28.

The red light reflected by dichroic mirror 21b enters field lens 24R via relay lens 23a, reflection mirror 22b, relay lens 23b, and reflection mirror 21c. The light transmitted through field lens 24R is sequentially transmitted through entrance side polarization plate 25R and liquid crystal light bulb 26R to enter exit side polarization plate 27R. The light transmitted through exit side polarization plate 27R enters cross dichroic mirror 28.

Each color light that has entered cross dichroic mirror 28 enters projection lens 30. Specifically, the red light and the blue light are reflected by cross dichroic mirror 28 to enter projection lens 30, and the green light is transmitted through cross dichroic mirror 28 to enter projection lens 30. The light that has entered projection lens 30 is magnified and projected to the screen or the like by projection lens 30.

The embodiments of the present invention have been described. However, the embodiments are in no way limitative of the invention. Various changes understandable to those skilled in the art can be made of the configuration of the present invention within the spirit and the scope of the invention.

1. A fly eye lens comprising:
a plurality of cells arranged on a first plane, wherein:
the plurality of cells includes a pair of cells adjacent to each other, which have spherical centers on a second plane parallel to the first plane and parts of spherical surfaces whose spherical radius differ from each other, those parts being surfaces; and
the pair of cells satisfies the following relationship, where R_{I} is a spherical radius of the surface of one of the cells, R_{O} is a spherical radius of the surface of the other cell, L_{I} is a distance between the spherical center of the surface of one of the cells and a boundary surface between the pair of cells, and L_{O} is a distance between the spherical center of the surface of the other cell and the boundary surface.
R_{O}=\sqrt{R_{I}²−L_{I}²+L_{O}²} [Expression 1]

2. The fly eye lens according to claim 1, wherein in the pair of cells, a radius of the surface of the cell located outside is larger than that of the cell located inside.

3. The fly eye lens according to claim 1, wherein the plurality of cells includes a plurality of pairs of cells.

4. An optical unit comprising:
the fly eye lens according to claim 1; and
a second fly eye lens disposed to face the fly eye lens.

5. A projection display device comprising:
an illumination optical unit that includes a light source and the optical unit according to claim 4 through which light emitted from the light source is transmitted;
an image forming unit that modulates the light emitted from the illumination optical unit based on an image signal; and
a projection optical system that projects the light modulated by the image forming unit.

6. The fly eye lens according to claim 2, wherein the plurality of cells includes a plurality of pairs of cells.

7. An optical unit comprising:
the fly eye lens according to claim 2; and
a second fly eye lens disposed to face the fly eye lens.

8. An optical unit comprising:
the fly eye lens according to claim 3; and
a second fly eye lens disposed to face the fly eye lens.
